(19) United States
(12) Patent Application Publication
(10) Pub. No.: US 2010/0199283 A1
(43) Pub. Date: Aug. 5, 2010

(54) DATA PROCESSING UNIT

(75) Inventors: Hideaki KIDO, Hitachi (JP); Shoji MURAMATSU, Hitachinaka (JP); Yasuhiko HOSHI, Iruma (JP); Hiroyuki HAMASAKI, Kodaira (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/698,246

(22) Filed: Feb. 2, 2010

(30) Foreign Application Priority Data
Feb. 4, 2009 (JP) 2009-023274

(51) Int. Cl. G06F 9/48; G06F 9/50; G06F 13/24

(52) U.S. Cl. 718/103; 718/108; 710/260

(57) ABSTRACT

When a CPU is processing a first task by using an accelerator for use in image processing, if a request for allocating the accelerator to a process of a second task is issued, the CPU sets an interruption flag when the process of the second task is prioritized over a process of the first task, and the accelerator is allowed to be used for the process of the second task when a state in which the interruption flag is set is detected at a timing predetermined in accordance with a process stage of the accelerator for the first task. Since the timing of detecting the set interruption flag is determined in accordance with a progress state of the process of the task to be interrupted, task switching can be made at a timing of reducing overhead for save and return for the process of the task to be interrupted.

### CROSS-REFERENCE TO RELATED APPLICATION

The present application claims priority from Japanese Patent Application No. JP 2009-023274 filed on Feb. 4, 2009, the content of which is hereby incorporated by reference into this application.

### TECHNICAL FIELD OF THE INVENTION

The present invention relates to an image processing unit supporting a multitask operation that achieves a plurality of image processing functions, and in particular to an image processing unit capable of interrupting image processing.

### BACKGROUND OF THE INVENTION

With the evolution of the computer technology and video technology, it has become important to achieve a plurality of image processing functions with one image processing unit. For example, in an image processing unit using a camera mounted on an automobile, it is desired to process a plurality of image processing functions such as pedestrian detection, rain detection and lane recognition with one image processing unit for the purpose of cost reduction. When such a plurality of image processing functions are executed with one unit, the computer divides these functions into smaller processing functions called tasks. Here, these tasks have their own priorities. For example, when an image processing task using a camera mounted on an automobile includes a rain detection task and a pedestrian detection task, the pedestrian detection task involving a brake control for avoiding a collision would be provided with a higher priority than the rain detection involving a wiper operation. Furthermore, in an image processing unit typified by that used in an automobile, a real-time process is expected in many cases, and as the priority of a task is higher, the task is more required to operate in real time and its delay is impermissible.

When a plurality of tasks are processed with one image processing unit, normally, in the state where a task occupies the image processing unit for executing image processing, image processing of another task is not executed irrespective of the level of priority until the former image processing ends. In other words, once the image processing unit is started for image processing, the image processing is not switched to another image processing until the former image processing ends. This poses a problem when a task with a low priority first occupies the image processing unit and then a delay-forbidden task with a high priority requests the execution of the image processing unit because a process of the task with a higher priority is delayed.

To get around the problem above, Japanese Patent Application Laid-Open Publication No. 2003-131892 (Patent Document 1) suggests an image processing unit in which, when a task with a low priority starts the image processing unit, a time when the image processing unit is started by a task with a high priority is estimated, and if an end time obtained by adding an execution time period to a start time of the image processing unit for the task with a low priority exceeds a start time of the task with a high priority, the execution of the image processing unit for the task with a low priority is performed later, and the execution of the image processing unit for the task with a high priority is performed first. In this manner, no delay occurs in the task with a high priority.

In another means for solving the problem, when a request for occupying an image processing unit is issued from a task with a high priority during the time when a task with a low priority occupies an image processing unit, information of the image processing unit is temporarily saved to interrupt the process of the task with a low priority, and after the image processing unit for the task with a high priority is started, the saved information is returned and then the remaining execution of the image processing unit for the task with a low priority is performed. As an example of the related art similar to the above, a technology disclosed in Japanese Patent Application Laid-Open Publication No. 08-161462 (Patent Document 2) is used. In this example of the related art, an image processing unit is disclosed, in which an enlargement/reduction circuit is provided with a function capable of interrupting an image processing to perform another image processing and then restarting the original image processing. By giving the interrupt and return function to the image processing unit for the task with a low priority as described above, the occurrence of a delay of the execution of the image processing unit for the task with a high priority can be prevented.

### SUMMARY OF THE INVENTION

For example, in an image processing unit mounted on an automobile, tasks to be processed with a high priority like pedestrian detection and tasks with a low priority compared with the pedestrian detection like rain detection are mixed together. At this time, it should be avoided that the task with a low priority occupies the image processing unit for a long time to obstruct the operation of the task with a high priority, resulting in a delay of the task with a high priority. In the case where the execution of the image processing unit for the task with a low priority is performed after the execution of the image processing unit for the task with a high priority ends in consideration of the execution time period of the task with a low priority and the execution time of the task with a high priority like in Patent Document 1, for example, when an occupying time period of the image processing unit for the task with a low priority is long and has a slight overlapping with the start time of the image processing unit for the task with a high priority, the time equivalent to the processing time of the image processing unit for the task with a low priority is wasted, and the image processing unit cannot be efficiently used. In particular, since some complex image processing functions take a long time, this problem becomes noticeable. Regarding this point, it can be said that Patent Document 2 solves this problem by interrupting the process of the image processing unit for the task with a low priority in midstream to start the process with a high priority, and then restarting the original image processing.

However, in Patent Document 2, the function is restricted to be in the enlargement/reduction circuit. This configuration is not sufficient for the image recognition requiring many image processing functions. Moreover, since all hardware information is saved at the time of interruption, the amount of time required for save and return and the capacity overhead are disadvantageously large. This problem is noticeable in an image processing unit having many image processing functions because there are a large number of internal information retaining means to be used and the time required for save and return and capacity overhead become large.

An object of the present invention is to provide a data processing unit capable of reducing overhead required for save and return in accordance with a state of progress of the process to be interrupted when a data processing is interrupted in midstream to prioritize another processing.

Another object of the present invention is to provide a data processing unit capable of switching the processes during the execution of image processing and also capable of appropriately selecting information required to be saved in accordance with the process being executed so as to reduce overhead at the time of the switching.

The above and other objects and novel characteristics of the present invention will be apparent from the description of this specification and the accompanying drawings.

The typical ones of the inventions disclosed in this application will be briefly described as follows.

That is, when the CPU is processing a first task by using an accelerator for use in image processing or the like, if a request for allocating the accelerator to a process of a second task is issued, the CPU sets an interruption flag when the process of the second task is prioritized over the process of the first task, and the accelerator is allowed to be used for the process of the second task by detecting a set state of the interruption flag at a timing predetermined in accordance with a process stage of the accelerator for the first task.

According to the above means, since the timing of detecting the set interruption flag is determined in accordance with a progress state of the process of the task to be interrupted, task switching can be made at a timing of reducing overhead for save and return for the process of the task to be interrupted.

The effects obtained by typical embodiments of the inventions disclosed in this application will be briefly described below.

That is, when a data processing is interrupted in midstream to prioritize another process, overhead required for save and return can be reduced in accordance with a state of progress of the process to be interrupted. More specifically, for example, process switching can be made during the execution of image processing, and information required to be saved can be appropriately selected in accordance with the process being executed so as to reduce overhead at the time of switching.

### BRIEF DESCRIPTIONS OF THE DRAWINGS

FIG. 1 is a block diagram depicting an example of an image processing unit according to the present invention;

FIG. 2 is a block diagram depicting details of an accelerator for image processing;

FIG. 3 is an explanatory diagram depicting an example of a task structure of an image processing task in the image processing unit;

FIG. 4 is a block diagram of an automobile to which the image processing unit is applied;

FIG. 5 is an operation flow depicting an example of an operation when a resource conflict for an image processing hardware unit occurs among a rain detection task, a lane departure detection task and a pedestrian detection task;

FIG. 6 is a control flow of an image hardware process for each task for achieving a task switching operation as typified in FIG. 5;

FIG. 7 is a control flow depicting details of an image hardware process in FIG. 6;

FIG. 8 is an explanatory diagram depicting an example of a process flow for reducing the amount of information to be saved at the time of task switching in the interruption determination of the image hardware process;

FIG. 9 is an explanatory diagram depicting an example of the configuration of a hardware management table;

FIG. 10 is an explanatory diagram depicting an example of the configuration of a task information management table;

FIG. 11 is an explanatory diagram depicting an example of the configuration of an image processing save information table;

FIG. 12 is an explanatory diagram depicting contents of a save process by a necessary information save process;

FIG. 13 is an explanatory diagram depicting an actual example of a queue;

FIG. 14 is an operation flow depicting an example of a task switching operation in a procedure different from that in FIG. 5; and

FIG. 15 is a task switching operation flow for suppressing overhead due to the repetitive save and return of an image hardware process of a low-priority task between the executions of a high-priority task performing the image hardware process plural times.

### DESCRIPTIONS OF THE PREFERRED EMBODIMENTS

### 1. General Outlines of Embodiments

First, general outlines of typical embodiments of the present invention disclosed in this application will be described. In the description of the general outlines of the typical embodiment, reference numerals in the drawings that are referred to with parentheses merely indicate things included in the concept of components to which theses reference numerals are provided.
[1] The data processing unit (10) according to the present invention comprises: a CPU (116) which processes a plurality of tasks; and an accelerator (106, 107, 108, 109) shared among processes of different tasks (103) in accordance with an instruction from the CPU. When the CPU is processing a first task by using the accelerator, if a request for allocating the accelerator to a process of a second task is issued, the CPU sets an interruption flag when the process of the second task is prioritized over a process of the first task, and the accelerator is allowed to be used for the process of the second task when a state in which the interruption flag is set is detected at a timing predetermined in accordance with a process stage of the accelerator for the first task. The detection whether the interruption flag is set may be performed directly by the accelerator or by the CPU.

According to the above means, the timing of detecting the set interruption flag is determined in accordance with the state of progress of the process of the task to be interrupted. Therefore, task switching can be made at a timing of reducing overhead for save and return for the process of the task to be interrupted.
[2] In the data processing unit according to the item [1], when the accelerator is allowed to be used for the process of the second task, the CPU saves data so that the process of the first task can be returned to a state immediately before interruption. The data may be saved by the accelerator.
[3] In the data processing unit according to the item [2], the data to be saved is determined in accordance with a detection timing of the interruption flag.
[4] In the data processing unit according to the item [3], the CPU refers to a table to determine the data to be saved. The determination of the data to be saved may be performed by a program description for the process. However, when it is performed by referring to a table, the reference timing thereof can be easily changed by the rewriting of the table.
[5] In the data processing unit according to the item [1], when the process of the second task does not have to be prioritized over the process of the first task, the CPU makes the process of the second task wait until the process of the first task is completed. Alternatively, the CPU makes the process of the second task wait for a given amount of time.
[6] In the data processing unit according to the item [1], the CPU determines whether the process of the second task is prioritized over the process of the first task based on a priority of each of the tasks. Alternatively, it may be determined based on the amount of processing time of each of the tasks.
[7] In the data processing unit according to the item [1], the CPU refers to a table to determine the timing predetermined in accordance with the process stage of the accelerator. The determination of the timing may be performed by a program description for the process. However, when it is performed by referring to a table, the timing thereof can be easily changed by the rewriting of the table.
[8] In the data processing unit according to the item [1], the accelerator includes an image processing hardware unit for image processing, a data buffer which temporarily stores data for image processing, and an image processing control unit which controls the image processing hardware unit and the data buffer in accordance with an instruction from the CPU. The image processing hardware unit is allowed to perform image processing by a repeat computation which repeats operations of computing image data supplied from the data buffer, writing back a computation result to the data buffer, and then performing computation using the written-back data and another data.

When data to be saved on the data buffer differs in accordance with the stage of repeat computation, the timing of detecting an interruption flag can be determined at each process break where an amount of data to be saved is decreased.
[9] The data processing unit according to the present invention comprises: a CPU which processes a plurality of tasks; and an accelerator shared among processes of different tasks in accordance with an instruction from the CPU. When the CPU is processing a first task by using the accelerator, if a request for allocating the accelerator to a process of a second task is issued, the CPU sets an interruption flag when the process of the second task is prioritized over a process of the first task and places the second task in a queue to wait for interruption of the first task, and when a state in which the interruption flag is set is detected by the accelerator at a timing predetermined in accordance with a process stage of the accelerator for the first task, data is saved so that the process of the first task can be returned to a state immediately before interruption, and the first task is placed in a queue to allow the accelerator to be used for the process of the second task.

According to the above means, since the timing of detecting the set interruption flag is determined in accordance with a progress state of the process of the task to be interrupted, task switching can be made at a timing of reducing overhead for save and return for the process of the task to be interrupted.
[10] In the data processing unit according to the item [9], the data to be saved is determined in accordance with a detection timing of the interruption flag.
[11] In the data processing unit according to the item [10], the CPU refers to a table to determine the data to be saved.
[12] In the data processing unit according to the item [9], the queue is assumed to be a task-priority-provided FIFO in which data written later can be read prior to data for a task having a priority lower than a priority of a task of the data written later.
[13] In the data processing unit according to the item [9], when the process of the second task does not have to be prioritized over the process of the first task, the CPU makes the process of the second task wait until the process of the first task is completed.
[14] In the data processing unit according to the item [9], the CPU refers to a table to determine the timing predetermined in accordance with the process stage of the accelerator.
[15] In the data processing unit according to the item [9] the accelerator includes an image processing hardware unit for image processing, a data buffer which temporarily stores data for image processing, and an image processing control unit which controls the image processing hardware unit and the data buffer in accordance with an instruction from the CPU. The image processing hardware unit is allowed to perform image processing by a repeat computation which repeats operations of computing image data supplied from the data buffer, writing back a computation result to the data buffer, and then performing computation using the written-back data and another data.

When data to be saved on the data buffer differs in accordance with the stage of repeat computation, the timing of detecting an interruption flag can be determined at each process break where an amount of data to be saved is decreased.

### 2. Details of Embodiments

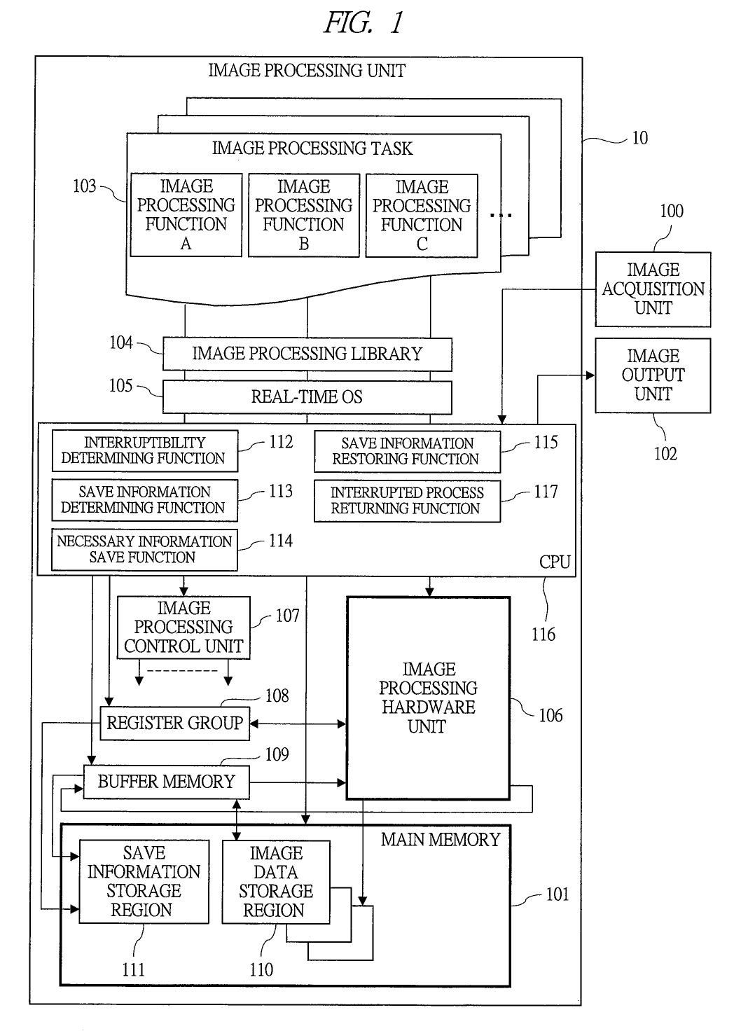

The embodiments are now described in more detail. FIG. 1 depicts an image processing unit according to the present invention. Although not particularly restricted, the image processing unit depicted in FIG. 1 is made up of a single chip or multi-chip as a data processor for image processing. When the image processing unit is made up of a single chip, it is implemented on one semiconductor chip as an LSI called a system on chip (SOC), and when the image processing unit is made up of a multi-chip, it is implemented as a module called a system in package (SIP).

In an image processing unit 10, video data is input from an image acquisition unit 100 such as a video camera, image pickup device or hard disk recorder. The image data acquired from the image acquisition unit 100 is stored in an image data storage region 110 of a main memory 101 as a recording medium including a synchronous dynamic random access memory (SDRAM), and is subjected to image processing. The image data subjected to image processing is displayed on an image output unit 102 such as a liquid crystal display.

The image processing unit 10 includes, in addition to the main memory 101, a central processing unit (CPU) 116 as a main computation device and also has image processing tasks 103 taken as software to be executed by the CPU 116, an image processing library 104 and a real-time OS 105 as an operating system. Tasks typified by the image processing task are given as so-called user programs. The image processing library 104 is taken as a program module provided in advance for image processing and is called and used by the tasks described above. As an image processing accelerator used when the CPU 116 processes the tasks described above, an image processing hardware unit 106, an image processing control unit 107, a register group 108 and a buffer memory 109 are provided. The image processing accelerator is used for executing various image processing tasks. In short, the operations of the image processing hardware unit 106, the image processing control unit 107, the register group 108 and the buffer memory 109 are defined in accordance with the contents of the image processing tasks 103, the image processing library 104 and the real-time OS 105. Although not particularly restricted, the image processing control unit 107 controls the image processing hardware unit 106 with the micro-program control in response to a command given from the CPU 116. When image processing is performed in a pipeline manner, the image processing hardware unit 106 can perform a parallel processing for each pipeline stage. Also, in the case of a configuration capable of performing a parallel processing of a plurality of tasks, plural sets of accelerator configuration described above are provided.

The image processing unit 10 executing a plurality of image processing tasks performs a task switching control by interrupting the execution of a task being executed, in accordance with the priority of the image processing task, the contents of the image processing by the image processing task and the state of progress of the image processing by the image processing task. In FIG. 1, as a control function for the task switching, the CPU 116 has an interruptibility determining function 112, a save information determining function 113, a necessary information save function 114, a save information restoring function 115 and an interrupted process returning function 117.

When the CPU 116 initializes the image processing hardware unit 106 in accordance with the image processing task 103 to start an operation thereof, the image processing hardware unit 106 and the image processing control unit 107 read image data specified by the image processing task 103 from the image data storage region 110 into the buffer memory 109. The image processing hardware unit 106 performs actual image processing to the image data read into the buffer memory 109, and then writes the process result in the image data storage region 110. After the image hardware process ends, the image processing task 103 is notified of the end of the process, and then the CPU 116 makes a transition to the execution of another task.

When a task is performing a process using the image processing hardware unit 106, if another task issues a request for occupying the image processing hardware unit 106, the image processing unit 10 performs the control as follows. That is, the interruptibility determining function 112 determines whether the image hardware process currently being executed can be interrupted, the save information determining function 113 determines information to be saved for interruption, the necessary information save function 114 saves that information, the save information restoring function 115 restores the saved information, and then the interrupted process returning function 117 returns the interrupted process to a state immediately after the interruption.

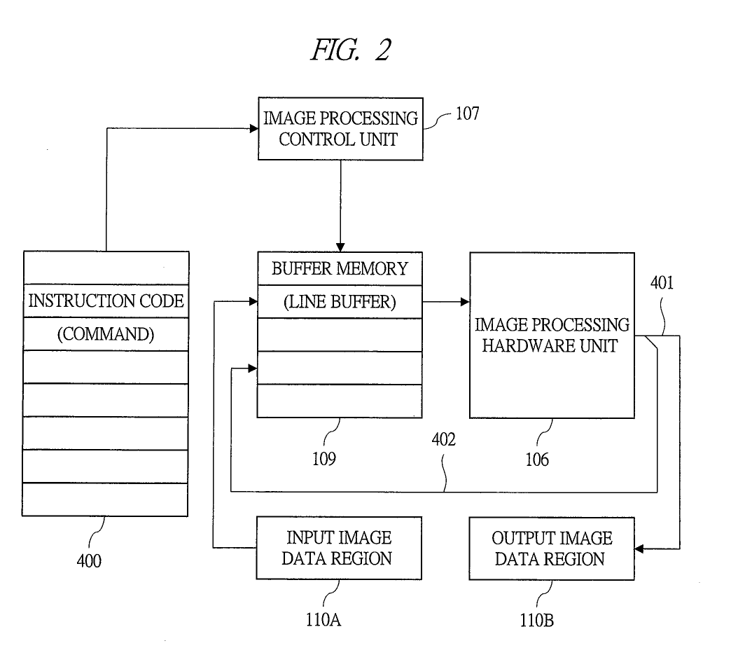

FIG. 2 depicts details of the accelerator for image processing. In the following description, the buffer memory 109 is configured as a line buffer that retains information of display lines of the image. Here, the buffer memory 109 can be configured as a block memory that processes an image in units of small region instead of a memory that processes an image in units of line.

The image processing modes in the configuration depicted in FIG. 2 include, firstly, a mode in which data is read from an input image data region 110A to the buffer memory 109, an image hardware process is executed in the image processing hardware unit 106, and the process result is returned to the output image data region 110B via a data path 401, and secondly, a mode in which the process result obtained by the image processing hardware unit 106 is written again in the buffer memory 109 via a data path 402 to execute an image hardware process again. The second image processing mode is suitable for a process mode of executing a plurality of image processings at a time by repeatedly using the image processing hardware unit 106, and such a process is hereinafter referred to as a repeated image processing. The repeated image processing may be a process of repeating the same image hardware process as one image processing or may be a process of combining different image hardware processes as one image processing. The repeated image processing is controlled by the image processing control unit 107 using a control signal generated by decoding an instruction code or command 400 provided in advance to control the buffer memory 109 and the main memory 101. The instruction code or command 400 has codes for controlling read and write of image data, execution of image processing, read and write of a register or memory, and others.

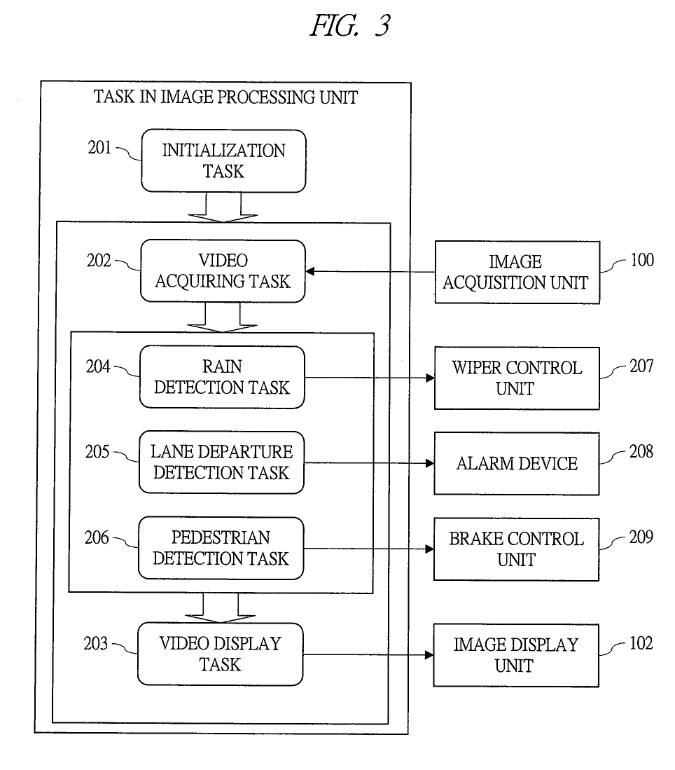

FIG. 3 depicts an example of a task structure of the image processing task 103 in the image processing unit 10. In this example, an image processing unit for automobiles is assumed, and a driving support for automobiles using image processing is assumed as an image processing function.

First, an initialization task 201 for an application is started, and a video acquisition task 202 acquires an image from the image acquisition unit 100 at a predetermined timing. Then, after a predetermined process is completed, a video display task 203 projects the result onto the image display unit 102.

Here, examples of driving support functions are a rain detection task 204, a lane departure detection task 205 and a pedestrian detection task 206.

The rain detection task 204 detects raindrops through image processing, and transmits the result to a wiper control unit 207.

The lane departure detection task 205 detects a lane departure, and transmits the result to an alarm device 208.

The pedestrian detection task 206 detects a pedestrian ahead of the vehicle, and transmits the result to a brake control unit 209.

The functions of the initialization task 201, the video acquisition task 202, the video display task 203, the rain detection task 204, the lane departure detection task 205 and the pedestrian detection task 206 are executed under the management of the real-time OS 105 supporting a multitask operation. Although tasks more than those described above are present in an actual data processing environment, these other tasks are not described herein for the purpose of easy understanding, and the description will be made based on the task structure depicted in FIG. 3.

Note that the wiper control unit 207, the alarm device 208 and the brake control unit 209 are the functions outside the image processing unit. Since the initialization task 201, the video acquisition task 202, the video display task 203, the wiper control unit 207, the alarm device 208 and the brake control unit 209 do not directly relate to the gist of the present invention, they are not described in detail here.

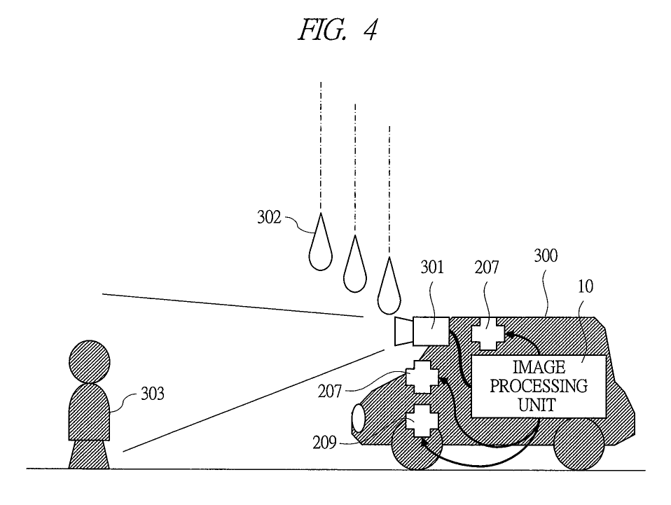

FIG. 4 depicts an automobile, which is an example of the application of the image processing unit 10. At the rear of a front glass of an automobile 300, a vehicle-mounted camera 301 is placed. The image processing unit 10 detects raindrops 302 falling on the front glass and a pedestrian 303 ahead of the vehicle, and transmits the result of the detection of the raindrops to the wiper control unit 207, the result of the detection of lane departure to the alarm device 208, and the result of the detection of the pedestrian to the brake control unit 209.

In FIG. 3, each of the three tasks, that is, the rain detection task 204, the lane departure detection task 205 and the pedestrian detection task 206 has its own priority as an index for determining which task is prioritized for process. When each priority is represented by Priority (task name), the following relation is assumed: that is, Priority (rain detection task)<Priority (lane departure detection task)<Priority (pedestrian detection task). This means that the act of avoiding the pedestrian in the light of the degree of danger of the detected pedestrian is prioritized as a delay-forbidden process over the control of a wiper with the detection of raindrops or the issuance of an alarm upon the detection of lane departure.

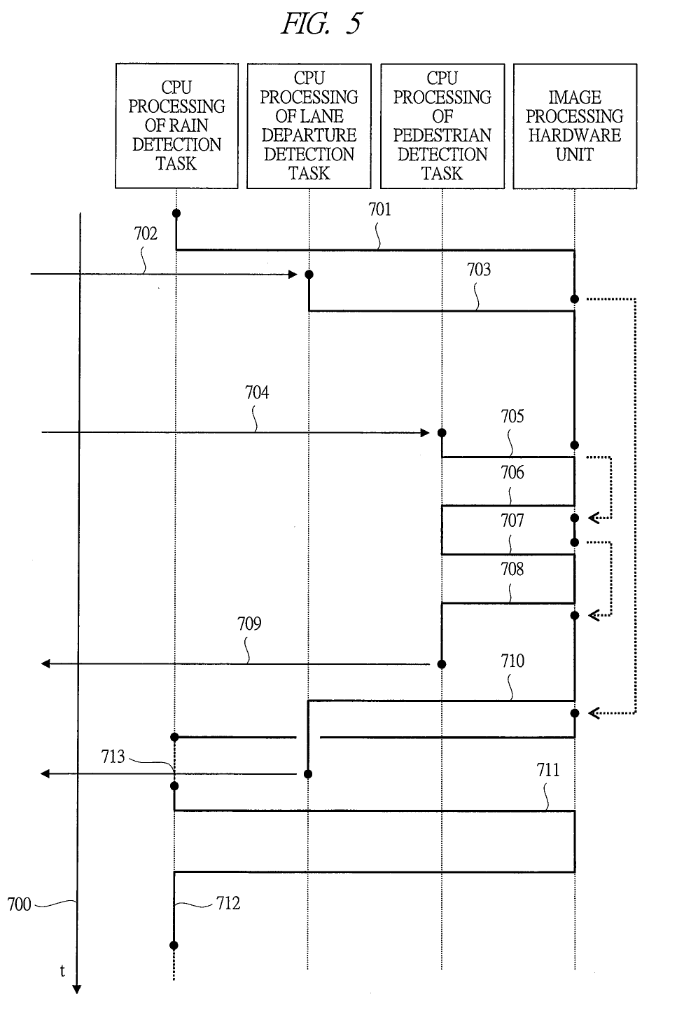

An operation expected when a resource conflict for the image processing hardware unit occurs among the rain detection task 204, the lane departure detection task 205 and the pedestrian detection task 206 will be described based on FIG. 5.

In FIG. 5, a time axis 700 extends in a vertical direction, and a bold vertical line indicates that a certain process is being performed on the extended line. A bold horizontal line indicates a transition of a process. A bold dotted line indicates some wait state. It is assumed in FIG. 5 that the image hardware process occurs twice for the rain detection task 204, once for the lane departure detection task 205, and twice for the pedestrian detection task 206. It is assumed that the image processing hardware unit 106 is initially started by the rain detection task 204 for the first time. Next, the case where the lane departure detection task 205 is started (702) and the lane departure detection task 205 issues a request for occupying the image processing hardware unit 106 (703) is considered. In the state where the rain detection task 204 uses the image processing hardware unit 106, the lane departure detection task 205 issues a request for occupying the image processing hardware unit 106. This state is referred to as an occurrence of a resource conflict of the image processing hardware unit 106. When a resource conflict occurs, image processing of the task with a higher priority is prioritized. As a result of the resource conflict by the occupation request 703, since Priority (lane departure detection task) is higher than Priority (rain detection task), the process of the image processing hardware unit 106 makes a transition to the lane departure detection task 205. Next, the case where the pedestrian detection task 206 is started (704) after the execution right of the image processing hardware unit 106 makes a transition as described above is considered. When the pedestrian detection task 206 issues a request for occupying the image processing hardware unit 106 (705), since the lane departure detection task 205 still executes the image processing hardware unit 106, a resource conflict occurs again. Here, Priority (pedestrian detection task) is higher than Priority (lane departure detection task), and therefore the execution right of the image processing hardware unit 106 makes a transition to the pedestrian detection task 206, and the hardware process of the lane departure detection task 205 enters a wait state. When the execution right of the image processing hardware unit 106 makes a transition to the pedestrian detection task 206 and the first execution of the image processing hardware unit 106 ends (706), the lane departure detection task 205, which entered a wait state because of the switching of the execution right of the image processing hardware unit 106 by the occupation request 705, is returned to the process using the image processing hardware unit 106. Next, the pedestrian detection task 206 issues a second occupation request 707 for the image processing hardware unit 106. Then, a resource conflict occurs again, the execution right of the image processing hardware unit 106 makes a transition to the pedestrian detection task 206, and the hardware process of the lane departure detection task 205 again enters a wait state. When the second execution of the image processing hardware unit ends at 708, the lane departure detection task 205, which entered a wait state because of the occupation request 706, is returned to the process using the image processing hardware unit 106. It is assumed that the pedestrian detection task 206 ends its operation (709) during that.

Then, the execution right of the image processing hardware unit 106 is returned to the lane departure detection task 205. Thereafter, after the remaining image processing ends (710), the execution right of the image processing hardware unit 106 is next returned to the rain detection task 204 (711), and the execution of the image processing remaining at the time of 703 ends (712). The lane departure detection task ends its operation (713) during that.

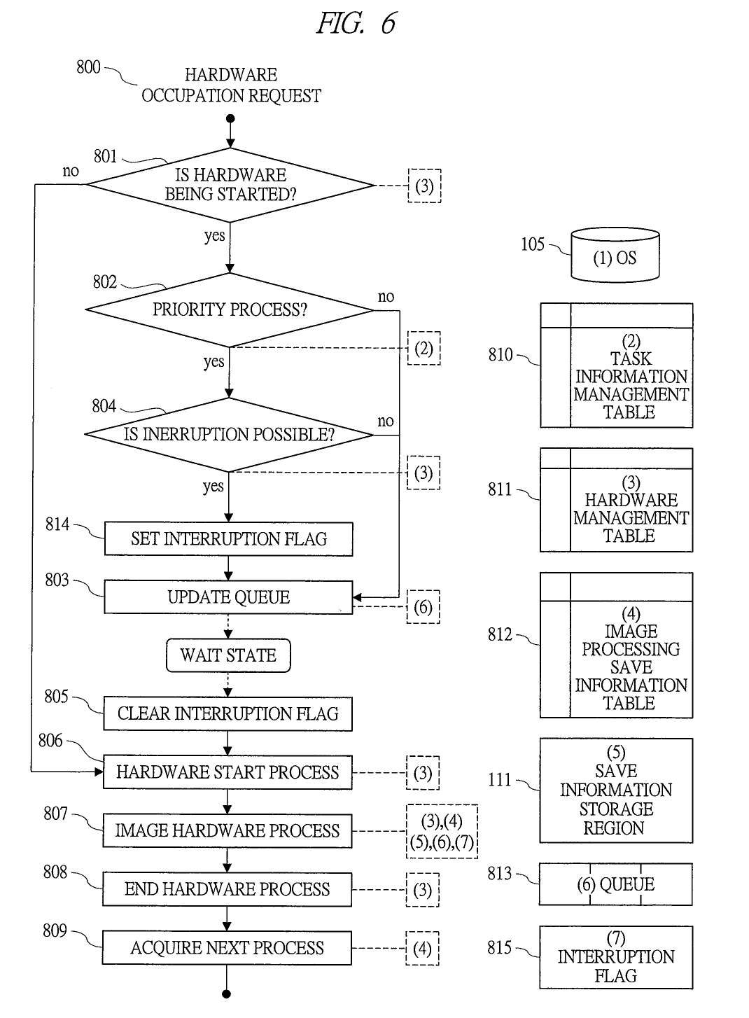

FIG. 6 depicts an example of a process flow of an image hardware process for each task for achieving a task switching operation as typified in FIG. 5. In FIG. 6, an arrow with a solid line indicates a transition of a process, and a dotted line indicates that the relevant process refers to or updates a table in parentheses.

When a task issues a hardware occupation request 800, it is first checked to see whether the image processing hardware unit 106 is being started, that is, whether another task does not occupy the image processing hardware unit 106 (801). When the image processing hardware unit 106 is not being started, the procedure goes to a process of staring hardware (806). When the image processing hardware unit 106 is being started, the procedure goes to a process of determining a priority (802), and it is determined whether its own task has a priority higher than that of the task operating the currently-activated image processing hardware unit 106. At this time, a task ID of the own task is acquired from the real-time OS 105, a task ID of the hardware process being executed is acquired from a hardware management table 811, and the priority of each task is acquired with reference to a task information management table 810. If available, the priority of an arbitrary task can be acquired by a service call of the real-time OS.

When the own task has a higher priority in the priority process determination 802, the procedure goes to a next interruptibility determining process (804). Otherwise, the procedure goes to a queue updating process (803) to update a queue 813 and enters a wait state.

In the interruptibility determining process (804), it is checked to see whether the process currently being executed can be interrupted with reference to the hardware management table 811. When the process can be interrupted, an interruption flag 815 is set (814), and then a queue update is performed to place the own task in the queue 813 (803), thereby making a transition to a wait state. Although details are described further below, the task that can be interrupted and is currently being executed is subjected to a process for interruption by detecting the interruption flag at a predetermined timing, and is then placed in the queue. By this means, the task having a higher priority level and placed earlier in the queue leaves the queue and becomes executable. When the task cannot be interrupted, the procedure similarly goes to a queue updating process (803), the queue 813 is updated, and a transition is made to a wait state. Here, the queue 813 is, for example, a priority-provided FIFO configured in a first-in first-out basis, in which data written earlier and having a higher priority is read first.

When the task leaves the queue, the interruption flag is cleared (805), necessary internal initialization and others are performed by a hardware start process (806), and then an image hardware process (807) is performed. More specifically, when a transition is made from a wait state to a run state, after necessary information such as a register group for the image processing hardware unit 106 is set as required, the hardware process by the image processing hardware unit 106 is started (806). When the image processing hardware unit 106 is started (806), an image hardware process and information about tasks to be operated by itself are registered in the hardware management table 811. After the start, the procedure goes to an image hardware process (807). When the image hardware process ends, after the end of the hardware process (808), a head image hardware process with a high priority in a process wait state in the queue 813 is called by the process of acquiring a next process (809).

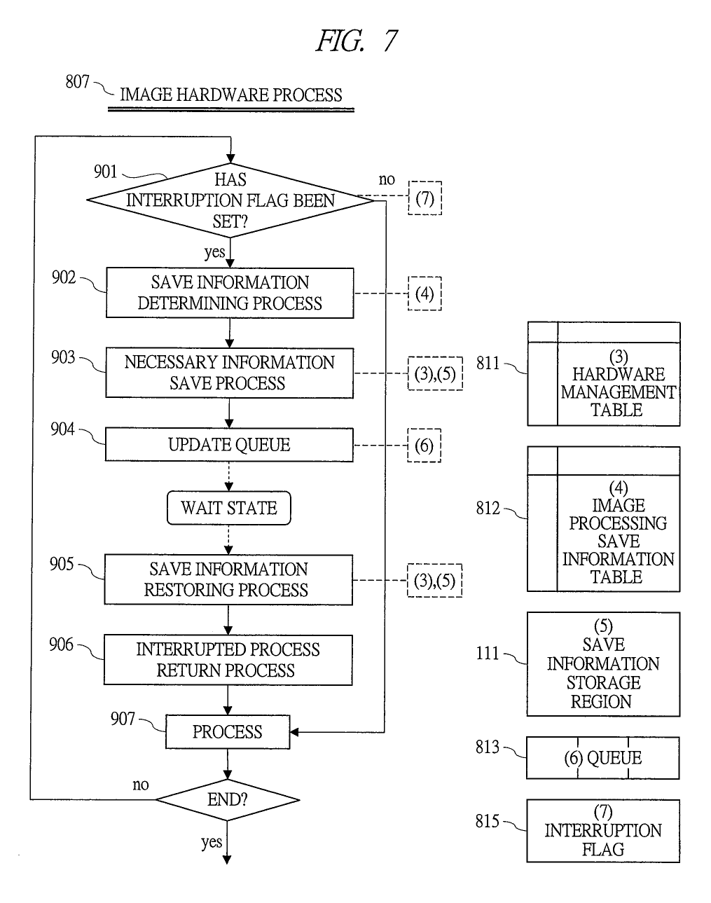

FIG. 7 depicts details of the image hardware process (807). In the image hardware process (807), an interruption flag is detected at a predetermined timing (901). That is, it is detected whether an interruption flag is set by a task with a priority higher than that of the own task.

When an interruption flag is not set, the process of the task is performed (907).

When an interruption flag is set, this means that a request for interrupting the execution of the task is issued by another task with a priority higher than that of the own task being processed (907). Therefore, when a set state of an interruption flag is detected, save information is appropriately selected in a save information determining process (902) and is then saved in a necessary information save process (903) as a save process regarding the execution of the task. Examples of the save information include values of the register group 108, stored data in the buffer memory 109, internal data of the image processing hardware unit 106 and the state of the image processing control unit 107. Examples of a register for save are a register that determines a function of the image hardware process, a register that retains how far the image hardware process has progressed in the image memory, and others.

At this time, the save information is determined with reference to an image processing save information table 812. In accordance with the save information, data is saved in a save information storage region 111 in a necessary information save process (903). Thereafter, the own task is placed in the queue 813, and a transition is made to a wait state. After a task with a low priority makes a transition to a wait state (904), the task with a high priority level requesting the interruption leaves the wait state (803) to make a transition to a ready state (805, 806 and 807).

In FIG. 7, when the task leaves the wait state and makes a transition to a run state, as a return process for reexecuting the interrupted task, the information saved in the necessary information save process (903) is first returned from the save information storage region 111 in the save information restoring process (905), and an image processing hardware unit 106 is appropriately started by, for example, performing a hardware initializing process in accordance with the interrupting position and the image processing function in an interrupted process return process (906). Then, the image processing by that task is restarted (907).

By providing an interruption flag for requesting the interruption of the execution of the task with a priority lower than that of the own task and an interruption flag determining process (901), a timing for interrupting the task process using the image processing hardware unit can be arbitrarily specified. In short, whether to interrupt can be determined with reference to the interruption flag in accordance with the state of the progress of the task process for which interruption is required. In particular, a point where only a small amount of information is to be saved at the time of task switching is selected as a determining timing of the interruption flag, thereby reducing overhead in time and capacity required for save and return. For example, the determination of the interruption flag can be performed at the timing when the process of one line of image data ends or at the timing of the break of one image processing when a plurality of image processings are repeatedly performed at once. When an interruption flag determination is made in such a point, save information can be reduced compared with the case of interruption at a random point in the course of the image processing.

The appropriate position for interrupting the task differs depending on the image hardware process. Therefore, the interruption flag determination position should be appropriately determined depending on the image hardware process.

In FIGS. 1, 6 and 7, for example, the interruptibility determining function 112 in FIG. 1 corresponds to the priority process determination (802) and the interruptibility determination (804); the save information determining function 113 corresponds to the save information determining process (902) and the image processing save information table 812; the necessary information save function 114 corresponds to the necessary information save process (903); the save information restoring function 115 corresponds to the save information restoring process (905); and the interrupted process returning function 117 corresponds to the interrupted process return process (906).

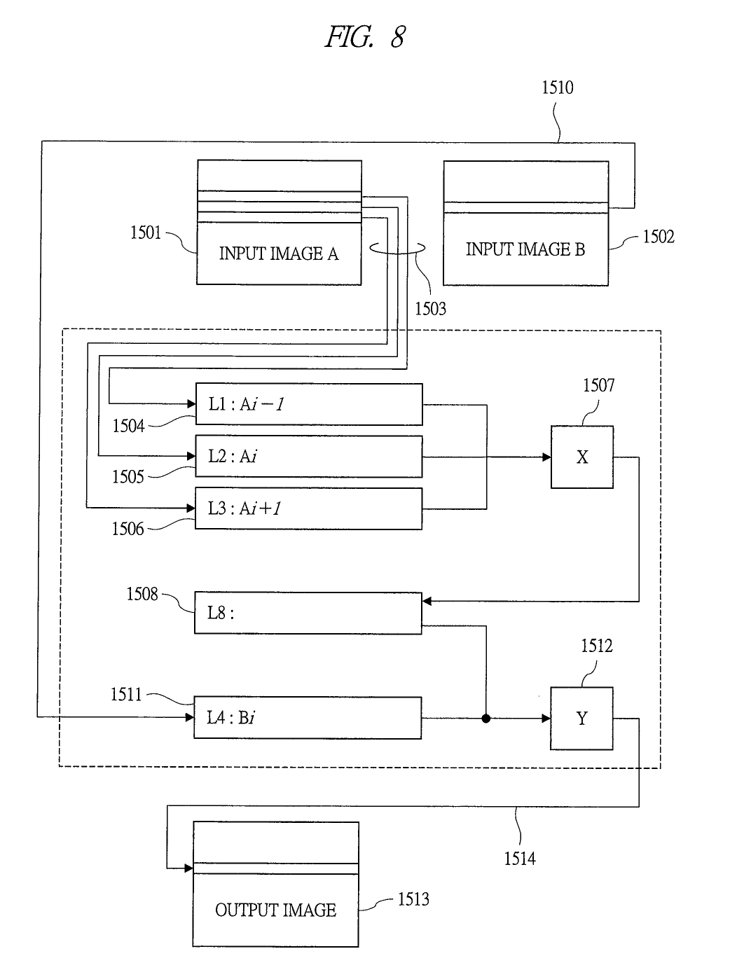

As described above, the interruption determination of the image hardware process is performed at the point when the amount of information to be saved is small at the time of task switching. Such a point when the amount of information to be saved is small within one process is depicted based on an example in FIG. 8. In the process depicted in FIG. 8, an input image A (1501) and an input image B (1502) are taken as inputs, a 3×3 smoothing process is performed on the input image A (1501), and then a difference from the input image B (1502) is taken and output to an output image 1513. Details of a process flow are described with taking an i-th line of the input image A (1501) as an example.
(1) Image data on an i-th line of the input image A, an (i−1)-th line immediately preceding thereto and an (i+1)-th line immediately subsequent thereto are read to line buffers (1503).
(2) The image data on the (i−1)-th, i-th and (i+1)-th lines are written in a line buffer L1 (1504), a line buffer L2 (1505), and a line buffer L3 (1506), respectively.
(3) These three lines are processed by a computing unit X (1507) for 3×3 arithmetic operation, and the result is stored in a line buffer L8 (1508).
(4) Image data is read from an i-th line of the input image B to a line buffer L4 (1511).
(5) With taking the line buffer L8 and the line buffer L4 as inputs, a computing unit Y (1512) performs a differential operation (1512), and the result thereof is written in an i-th line of the output image 1513.

The series of processing is repeated for all lines and a 3×3 smoothing process of the input image A (1501) is performed. Then, the function of taking and outputting a difference from the input image B (1502) is achieved. The series of instruction control such as the execution of write, read and arithmetic operation is assumed to be performed by the image processing control unit 107.

In this case, when focusing the attention on the line buffers, the save amount required for return is smaller when the interruption is performed at (3) compared with the interruption performed at (2). This is because data on three line buffers L1, L2 and L3 have to be saved when the interruption is performed at (2), but data on only one line buffer L8 is saved when the interruption is performed at (3) and data on the other line buffers do not have to be saved.

Furthermore, if the processing of (1) to (5) is repeatedly performed for all lines to achieve a whole necessary image process, when interruption is performed at the time of the end of the series of processing of (1) to (5), data on any line buffer do not have to be saved, and the save amount can be further decreased. In this manner, since the save amount differs depending on the interruption position, an interruption flag is set at the point where the save amount is small, for example, after the end of (3) or (5), thereby interrupting the task process. By this means, the amount of processing and the resource use amount can be reduced and the interruption and return of the image processing can be efficiently performed.

In the description above, the line buffers are taken as an example. Also, as to the main memory, internal registers and others, the save amount required for return differs depending on the image processing and the interruption position. For example, when the image processing for pixel transformation by using a transformation table in the main memory is considered, the main memory has to be saved if interruption is performed in the midstream of this function, but saving is not required in the image processing without using such a transformation.

Also, in the example of FIG. 8, the image processing function is achieved by combining the line buffers and the computing devices. However, since such a combination itself variously changes depending on the image processing function, an appropriate interruption position is determined depending on the image processing function.

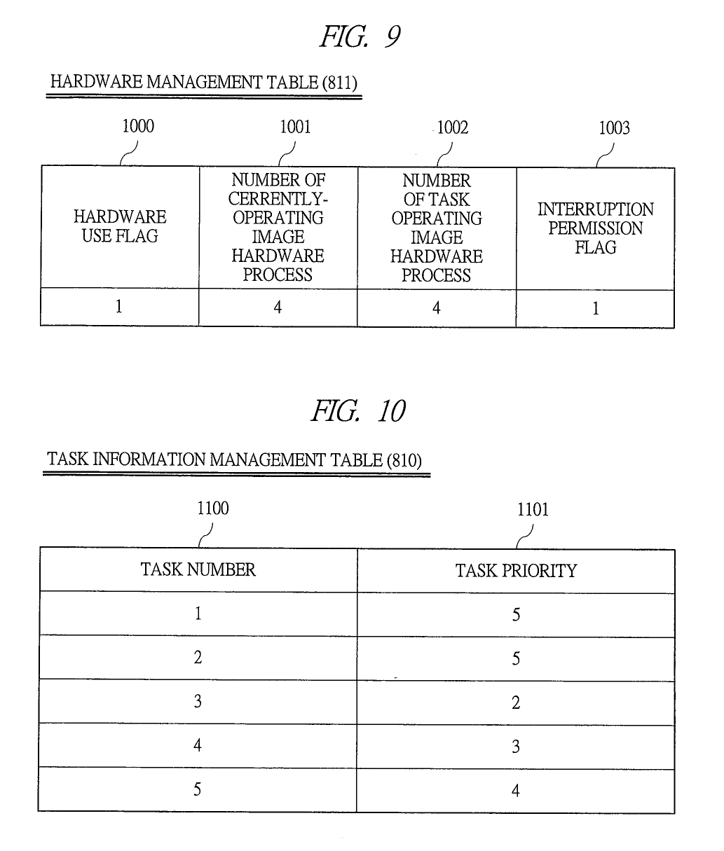

FIG. 9 depicts an example of the configuration of the hardware management table 811. This table manages the state of an accelerator for image processing (simply referred to as image processing hardware) such as the image processing hardware unit and retains a hardware use flag 1000 that manages whether the image hardware process is currently operating, a number of the currently-operating image hardware process (1001), a task number of a task that operates the image hardware process (1002) and an interruption permission flag (1003).

The interruption permission flag is a flag indicative of whether the currently-operating image processing hardware can be interrupted. If the flag is 1, the interruption is permitted, and if the flag is 0 the interruption is not permitted. For example, for an image hardware process with a long processing time, 1 is set because risk due to the delay of a task with a high priority is large unless the interruption is permitted. On the other hand, for an image processing with a short processing time, 0 is set when the risk due to the delay of a task with a high priority is determined to be small. Even for the same image processing, the setting of the flag can be changed depending on the magnitude of the process range.

In this manner, by dynamically switching whether to perform the interruption process, the process can be flexibly changed. Also, information about this interruption permission flag may be provided in the image processing save information table in advance so that the interruptibility determining unit can refer to this image processing save information table.

This hardware management table 811 reflects a change every time when whether the image hardware process is currently operating, the image hardware process currently operating, and the task number of a task operating the image hardware process are changed. For example, in FIG. 6, for a task to be executed first after a wait state, the process to be executed by the image hardware is switched in the hardware start process (806), and therefore, the information in the hardware management table 811 may be updated at this point.

FIG. 10 depicts an example of the configuration of the task information management table 810. This table manages the information about tasks and retains a task number (1100) and a task priority (1101).

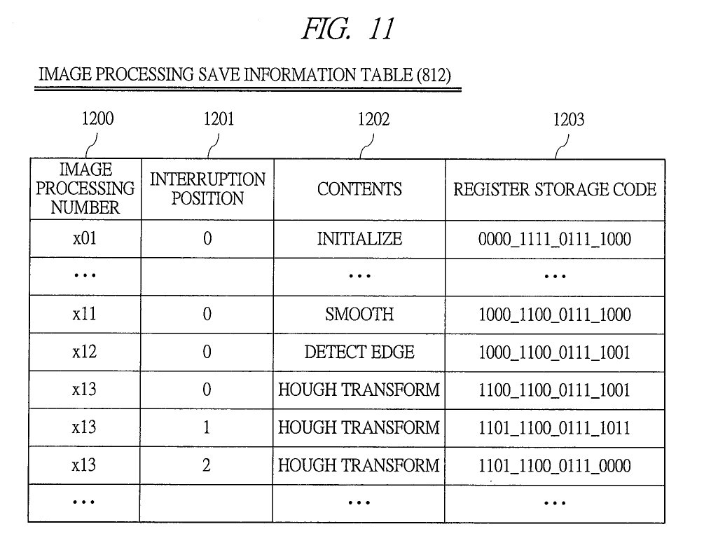

FIG. 11 depicts an example of the configuration of the image processing save information table 812. The image processing save information table 812 manages an interruption position (1201), contents of the image processing (1202) and a flag (1203) for specifying a register required at the time of save with using an image processing number as a key (1200). The flag for specifying a register required at the time of save can be such that, for example, a register number is assigned to each bit, data is saved when the bit is 1 and data of a register with a specified register number is not saved when the bit is 0. Other than registers, the line buffers and the information of the image processing control unit may be specified by these bit strings. By specifying and selecting the information to be saved in the manner, overhead for save can be reduced compared with the case of saving the entire information. Also, the information to be saved can be changed depending on the interruption position as depicted in Hough transformation in FIG. 11.

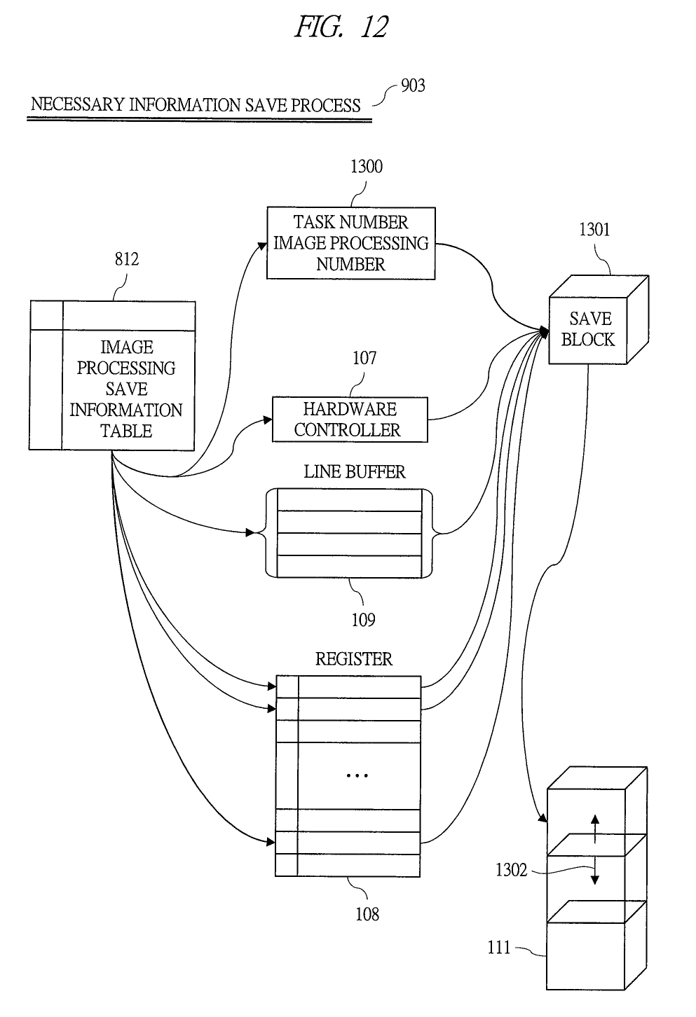

FIG. 12 depicts contents of a save process by the necessary information save process 903. In the necessary information save process 903, information specified by the image processing save information table 812 is saved. Examples of information to be saved are an address of the register 108, a register value to be stored, the state of the line buffer 109, and the internal state of the image processing control unit 107 (value of a general-purpose register or a value of a program counter). In addition, an example of the information to be necessarily saved includes a task number of a task issuing a request for image processing and an image processing number (1300). This number can be acquired by referring to the hardware management table 802. Also, although not illustrated, it is also possible to save an instruction code and an internal memory for use in retaining an image conversion table. As the actual save achieving method, a method of achieving the save as a circuit and a method of achieving the save while reading specified information in software are possible.

In the necessary information save process 903, the information is stored in the save information storage region 111, and the information to be saved at a time is referred to as a save block (1301). In the save block, a save target and save information are stored. The save target indicates, for example, a register or a line buffer, and the save information indicates contents of a register and a line buffer at the time of save. The save block may be provided in a divided manner like a register, a line buffer and an internals state of the image processing control unit or may be combined as depicted in FIG. 12. A function (1302) of varying a region length of one component to be saved (save block) is provided for the save information storage region 111. The reason why one save block is made variable is for a measure for the variation of the amount of save information and for the space saving of the save information storage region 111. However, if there are sufficient regions, the fixed length is allowed.

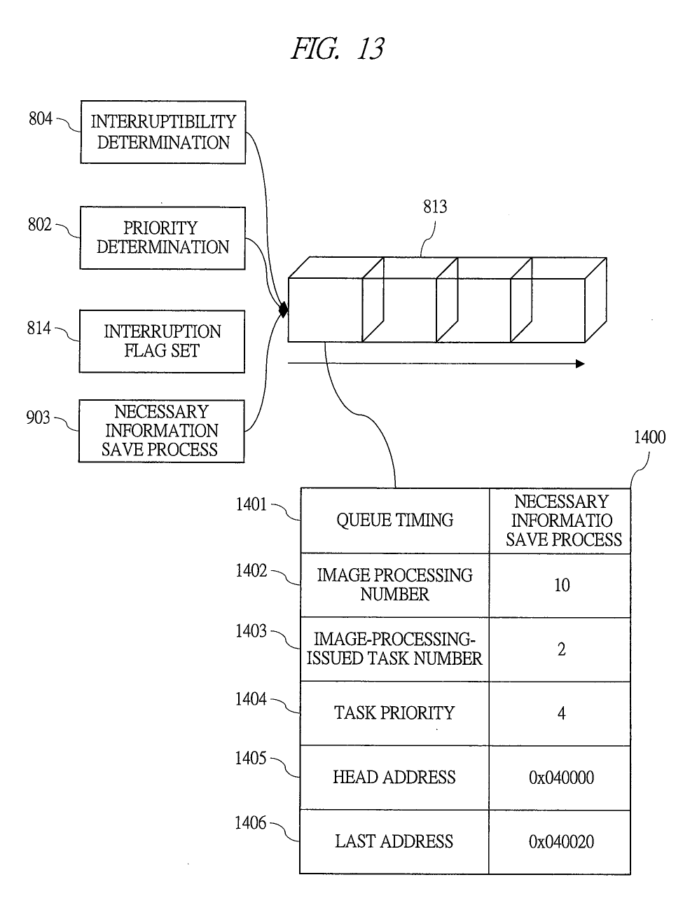

FIG. 13 depicts an example of an actual queue 813. Information of the image hardware process which cannot move at present but is to be a candidate to move next enters the queue 813. This head data is taken when the hardware process currently being executed ends or is interrupted.

As depicted in FIGS. 6 and 7, timings of entering the queue include a timing when the priority is lower than that of the task that executes the hardware in the priority determining process (802), a timing when it is determined in the interruptibility determining process (804) that the already-operating image hardware process cannot be interrupted, a timing after an interruption flag for interruption wait is set (814), and a timing after the necessary information save process (903) for performing a save process for interruption is performed. These timings are referred to as queue timings. Since the image hardware process entering the queue in the last interruption process has to be matched with the save information stored in the save information storage region 111, information about such matching (such as a task number and an image processing number) has to be retained.

The specific queue depicted in FIG. 13 can be implemented as a priority-provided queue. Here, the priority-provided queue is a queue in which an element entering later but having a high priority is allowed to be placed at a position preceding to positions of elements with a lower priority. With this priority-provided queue, even when a plurality of tasks enter, it is possible to prevent a situation of losing consistency such as the case where a low-priority task interrupts a high-priority task which is occupying the hardware.

Information elements 1400 for each image hardware process include a queue timing 1401, an image processing type (image processing number) 1402, an image-processing-issued task number 1403, and a task priority 1404. Furthermore, when the queue timing is a necessary information save process, a head address 1406 and a last address 1407 of the save information storage region 111 are retained. By retaining these two addresses, the hardware process interrupted by the necessary information save process can perform the easy return of the necessary information when the process is returned.

In addition to them, for example, a time stamp (CPU absolute time) when the state enters await state may be retained. The time stamp is used for updating the queue, for example, for the discrimination when information about the same image hardware process enters at different times, and for the transition of a process with a long wait time to the head in order to avoid a long wait state of a specific image hardware process.

The reason why the queue timing 1401 is retained is that processes required at the time of a transition from a wait state to a run state differ depending on the queue timing in some cases. For example, when the flow up to 801, 802, 804, 814 and 803 in FIG. 6 is implemented by a CPU process and the process in FIG. 7 is implemented by the image processing control unit 107, if the case of entering a wait state with the interruptibility determining process (804) taken as the queue timing and the case of entering a wait state with the necessary information save process 902 taken as the queue timing are compared, an additional process of priority comparison with a task currently performing a CPU process is required before a transition process to a run state in the former case. By achieving the above, the next process after a certain image hardware process ends can be appropriately determined.

In the save information restoring process 905, a save block at the head of the queue 813 is restored. In the case of 1400 in FIG. 13, for example, a save block of a task 2 returned from an interruption process has a head address of 0x040000 to a last address of 0x040020. Therefore, in accordance with the save block at this place, save information is restored to a register, line buffer, or the like. This operation is possible because the save block contains a save target and save information. Alternatively, since the save target can be known by referring to the image processing save information table 812, save can be performed in accordance with this information.

In the interrupted process return process 906, a pre-process required for restarting the interrupted process and a restart of the interrupted process are preformed. An example of the pre-process required for restarting the interrupted process is clearance of the information left before a return process and unnecessary at the time of restarting the interrupted process. Examples of such information include values of any line buffer and register. In addition, when the position where the image processing is interrupted and the position at the time of restarting the process are different from each other, the restart position and the process have to be adjusted. For example, in a local region process using information around the specified position for processing, information of a previous line has to be read, which may be determined from the image processing function and the interruption position contained in return information. After such adjustment, the interrupted process is restarted.

The fact that switching of the image hardware process is allowed in the procedure of FIGS. 6 and 7 is described with reference to FIG. 5. Here, it is assumed that any image hardware process issued from each task can be interrupted. First, when the rain detection task occupies the image processing hardware, the lane departure detection task issues a request for occupying the image processing hardware at 703. At this time, the image hardware process of the lane departure detection task checks to see whether the hardware is being started (801), and since the rain detection task performs an image hardware process, the procedure goes to the priority determination (802). Here, Priority (lane departure detection task) is higher than Priority (rain detection task), and therefore, the procedure goes to interruptibility determination 804. Since interruption is possible here, an interruption flag is set (814), and the process is added to the queue and temporarily enters await state. On the other hand, the image hardware process of the rain detection task refers to an interruption flag (901), and since an interruption flag is set, the process itself is added to the queue (904) and enters a wait state through the save information determination process 902 and the necessary information save process 903. The image hardware process of the lane departure detection task operates for a while, and then, the pedestrian detection task with the highest priority issues an occupation request at 705. Here, since Priority (pedestrian detection task) is higher than Priority (lane departure detection task) and interruption is possible, the lane departure detection task is added to the queue (904) through the interruption flag determining process (901), the save information determining process (902) and the necessary information save process (903). Here, although the rain detection task has already been in the queue, since Priority (lane departure detection task) is higher than Priority (rain detection task), the head of the queue is switched to the lane departure detection task in accordance with the property of the priority-provided queue. When a first image hardware process of the pedestrian detection task ends at 706 in FIG. 5, the next process acquiring process (809) of the image hardware process calls the image hardware process of the lane departure detection task interrupted at 705 and placed at the head of the queue and then exits from the hardware process. The called image hardware process of the lane departure detection task returns from the wait state, necessary information is re-written in a necessary position in the save information recovery process 905 and the interruption process return process 906, and then the hardware process is restarted, thereby starting the process (907). Thereafter, the interruption and return process similar to the above is performed also at the timings 707, 708 and 710 in FIG. 5.

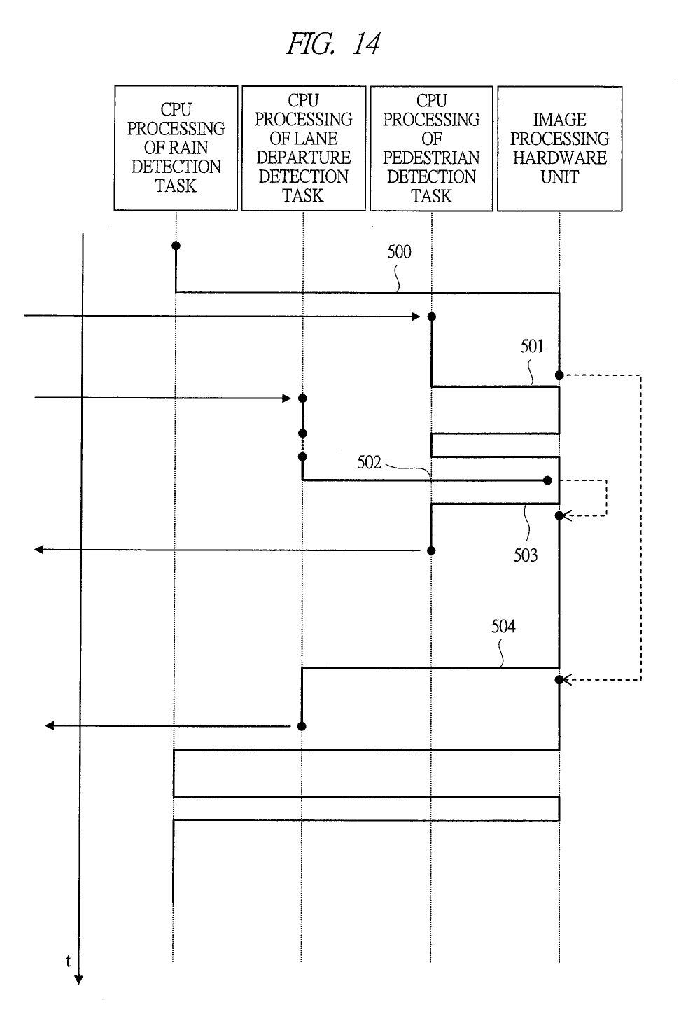

FIG. 14 depicts an example of a task switching operation timing in a procedure different from that in FIG. 5. In the example of FIG. 14, the interruptibility determination (804) is not performed after the priority process determination (802) in FIG. 6 and the procedure goes to queue updating. After the rain detection task first acquires the execution right of the hardware (500), the pedestrian detection task issues a request for occupying the image processing hardware (501), and a resource conflict occurs. Here, since Priority (pedestrian detection task) is higher than Priority (rain detection task), the pedestrian detection task acquires the execution right of the image processing hardware and executes the image hardware process of the pedestrian detection task. At this time, as to the image hardware process requested from the rain detection task, the queue timing 1301 is recorded in the necessary information save process, and the process is placed in the queue. During this, the lane departure detection task is executed, and a request for occupying the image processing hardware is issued at 502, so that a resource conflict occurs. However, since the priority of the pedestrian detection task is higher than the priority of the lane departure detection task, the image hardware process at 502 enters the queue, the image hardware process requested from the pedestrian detection task continues to be executed, and the image hardware process requested from the lane departure detection task enters the queue. During this, the queue timing 1301 is stored as priority determination. At this time, the image hardware process requested from the lane departure detection task enters the head of the priority-provided queue. Then, the image hardware process requested from the pedestrian detection task ends at 503 in FIG. 14, and the image hardware process requested from the lane departure detection task is next called and executed. Finally, the image hardware process requested from the lane departure detection task ends at 504 in FIG. 14, and the image hardware process of the rain detection task is returned and executed again.

In the examples depicted in FIGS. 5 and 14, when the pedestrian detection task with a high priority executes the image hardware process plural times, the image hardware process of the pedestrian detection task with a low priority is repeatedly saved and returned between the executions, for example, between 706 and 707. If overhead thereof delays the task with a high priority, the image processing of the task with a low priority can be prohibited until the task with a high priority ends. For the achievement of the configuration like this, the next process acquiring unit 809 refers to the hardware management table, and when the priority of the task requesting the image hardware process in the head of the queue is lower than the priority of the task currently occupying the hardware, the task at the head of the queue is not executed. In this case, the image hardware process at the head of the queue is returned at the last of the task.

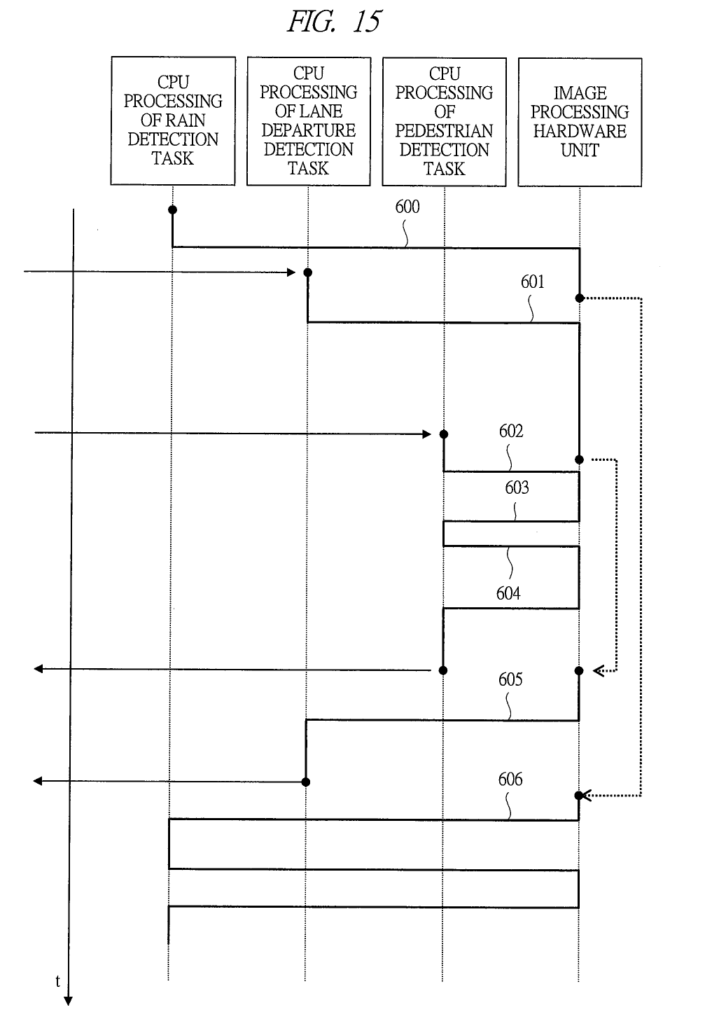

An example of operation timings in the above case is depicted in FIG. 15. An image hardware process of the rain detection task is executed at 600, and a request for occupying the image processing hardware is issued from the lane departure detection task at 601. The execution right of the image processing hardware moves to the lane departure detection task. Next, a resource conflict occurs between the pedestrian detection task and the lane departure detection task at 602, and the execution right of the image processing hardware moves to the pedestrian detection task. The image hardware process of the pedestrian detection task once ends at 603, but the hardware process of the lane departure detection task is not returned, and the next image hardware process of the pedestrian detection task is started at 604. The image hardware process of the lane departure detection task is returned only after the pedestrian detection task ends (605), and the hardware process of the rain detection task is returned only after the lane departure detection task ends (606).

In the foregoing, the invention made by the inventors of the present invention has been concretely described based on the embodiments. However, it is needless to say that the present invention is not limited to the foregoing embodiments and various modifications and alterations can be made within the scope of the present invention.

For example, a plurality of sets of the image processing hardware unit 106, the image processing control unit 107, the register group 108 and the buffer memory 109 as an image processing accelerator may be provided. For example, when image processing is performed in a pipeline manner, a number of pairs of the above-mentioned circuits as many as the number of pipeline process stages may be provided. Also, instead of implementing both of the process in FIG. 6 and the process in FIG. 7 as CPU processing, the process in FIG. 6 may be implemented as CPU processing and the process in FIG. 7 may be implemented as accelerator processing. The data processing unit according to the present invention is not meant to be restricted to that used for image processing, but can be widely applied to those used for audio processing, encoding processing, and others.

What is claimed is:

1. A data processing unit comprising:
a CPU which processes a plurality of tasks; and
an accelerator shared among processes of different tasks in accordance with an instruction from the CPU, wherein
when the CPU is processing a first task by using the accelerator, if a request for allocating the accelerator to a process of a second task is issued, the CPU sets an interruption flag when the process of the second task is prioritized over a process of the first task, and the accelerator is allowed to be used for the process of the second task when a state in which the interruption flag is set is detected at a timing predetermined in accordance with a process stage of the accelerator for the first task.

2. The data processing unit according to claim 1, wherein
when the accelerator is allowed to be used for the process of the second task, the CPU saves data so that the process of the first task can be returned to a state immediately before interruption.

3. The data processing unit according to claim 2, wherein
the data to be saved is determined in accordance with a detection timing of the interruption flag.

4. The data processing unit according to claim 3, wherein
the CPU refers to a table to determine the data to be saved.

5. The data processing unit according to claim 1, wherein
when the process of the second task does not have to be prioritized over the process of the first task, the CPU makes the process of the second task wait until the process of the first task is completed.

6. The data processing unit according to claim 1, wherein
the CPU determines whether the process of the second task is prioritized over the process of the first task based on a priority of each of the tasks.

7. The data processing unit according to claim 1, wherein
the CPU refers to a table to determine the timing predetermined in accordance with the process stage of the accelerator.

8. The data processing unit according to claim 1, wherein
the accelerator includes an image processing hardware unit for image processing, a data buffer which temporarily stores data for image processing, and an image processing control unit which controls the image processing hardware unit and the data buffer in accordance with an instruction from the CPU, and
the image processing hardware unit is allowed to perform image processing by a repeat computation which repeats operations of computing image data supplied from the data buffer, writing back a computation result to the data buffer, and then performing computation using the written-back data and another data.

9. A data processing unit comprising:
a CPU which processes a plurality of tasks; and
an accelerator shared among processes of different tasks in accordance with an instruction from the CPU, wherein
when the CPU is processing a first task by using the accelerator, if a request for allocating the accelerator to a process of a second task is issued,
the CPU sets an interruption flag when the process of the second task is prioritized over a process of the first task and places the second task in a queue to wait for interruption of the first task, and
when a state in which the interruption flag is set is detected by the accelerator at a timing predetermined in accordance with a process stage of the accelerator for the first task, data is saved so that the process of the first task can be returned to a state immediately before interruption, and the first task is placed in a queue to allow the accelerator to be used for the process of the second task.

10. The data processing unit according to claim 9, wherein
the data to be saved is determined in accordance with a detection timing of the interruption flag.

11. The data processing unit according to claim 10, wherein
the CPU refers to a table to determine the data to be saved.

12. The data processing unit according to claim 9, wherein
the queue is assumed to be a task-priority-provided FIFO in which data written later can be read prior to data for a task having a priority lower than a priority of a task of the data written later.

13. The data processing unit according to claim 9, wherein
when the process of the second task does not have to be prioritized over the process of the first task, the CPU makes the process of the second task wait until the process of the first task is completed.

14. The data processing unit according to claim 9, wherein
the CPU refers to a table to determine the timing predetermined in accordance with the process stage of the accelerator.

15. The data processing unit according to claim 9, wherein
the accelerator includes an image processing hardware unit for image processing, a data buffer which temporarily stores data for image processing, and an image processing control unit which controls the image processing hardware unit and the data buffer in accordance with an instruction from the CPU, and
the image processing hardware unit is allowed to perform image processing by a repeat computation which repeats operations of computing image data supplied from the data buffer, writing back a computation result to the data buffer, and then performing computation using the written-back data and another data.
